(19) United States
(12) Patent Application Publication
(10) Pub. No.: US 2018/0274070 A1
(43) Pub. Date: Sep. 27, 2018

(54) Biocompatible Ti-based metallic glass for additive manufacturing

(71) Applicant: National Central University, Taoyuan City (TW)

(72) Inventors: Jason Shiang-Ching JANG, Taoyuan City (TW); Chih-Ching HUANG, Kaohsiung City (TW); Che-Hsin LIN, Kaohsiung City (TW); Pei-Hua TSAI, Tainan City (TW); Tsung-Hsiung LI, Kaohsiung City (TW)

(21) Appl. No.: 15/792,476

(22) Filed: Oct. 24, 2017

(30) Foreign Application Priority Data
Mar. 23, 2017 (TW) 106109698

(51) Int. Cl. C22C 45/10; B22F 1/00; B22F 9/08; C22C 14/00; B33Y 70/00

(52) U.S. Cl. CPC C22C 45/10; B22F 1/0048; B22F 9/082; B22F 2304/10; B33Y 70/00; B22F 2009/0848; B22F 2301/205; C22C 14/00

(57) ABSTRACT

A biocompatible Ti-based alloy having a formula of TiₐZr_{w}Ta_{b}SiₓSn_{y}Co_{z} is disclosed, wherein a is 40-44, b is 1-5 and the sum of w, x, y, z is 55. The alloy is amorphous. The alloy is applicable to manufacturing ultrafine powder which is used for additive manufacturing. The alloy is characterized in high glass forming ability, low toxicity, and high strength, and the powder thereof has low roughness and high circularity, and is suitable for implantable medical device.

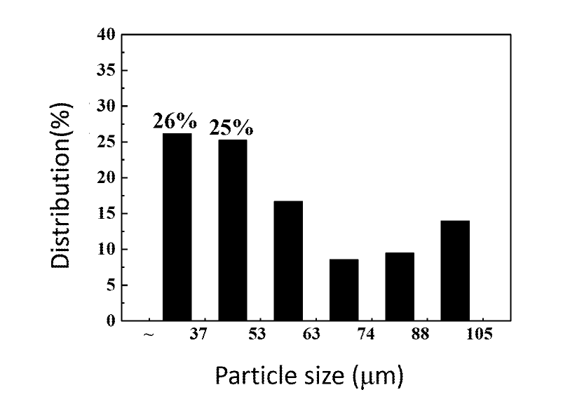

### CROSS REFERENCE TO RELATED APPLICATION

This application claims the benefits of the Taiwan Patent Application Serial Number 106109698, filed on Mar. 23, 2017, the subject matter of which is incorporated herein by reference.

### BACKGROUND

### 1. Field of the Invention

The present invention relates to a biocompatible Ti-based alloy that has high glass forming ability, wherein the alloy is applicable for making ultrafine powders, and is suitable for additive manufacturing.

### 2. Description of Related Art

Titanium or Ti-based alloy features for high strength, good corrosion resistance, good heat resistance, and high biocompatibility, and has been extensively used in various industries, particularly in medical devices, such as in vertebral fixation devices, artificial joints, diaphysis of artificial hip joints, tibial baseplates, artificial dental roots and so on. This material has a low elastic coefficient. If the material of an implant has an unmatching Young's modulus, when resiliently flexural deformation happens, the huge difference in Young's modulus can prevent a bone from evenly distributing loads over the material of the implant, and this can damage human body tissue and procrastinate the patient's recovery.

Additive manufacturing, also known as 3D printing, refers to a technology involving printing objects three-dimensionally by continuously adding and stacking material under a computer's control. Different from the traditional processing method that makes products through grinding, forging, welding and more, additive manufacturing makes objects by means of stacking.

Ti-based alloy metallic glass is a glass structure without grains and grain boundaries. When made into powders through atomization, it can achieve low surface roughness because there are no different grain sizes that affect the resulting powder surface. Therefore, Ti-based alloy metallic glass is a great source for powders having smooth surface that is desired in additive manufacturing. More properties of Ti-based alloy metallic glass include low liquid phase temperature, low enthalpy of fusion, and low residual stress.

In the prior art, U.S. Pat. No. 6,786,984 discloses a Ti-based alloy for dental or orthopedic devices, which comprises Sn, Ti or Zr, and Nb or Ta, wherein the content of Nb or Ta (as its molecular proportion) in the alloy is 8-20%, and the content of Sn is 2-6%. But the glass forming ability (GFA) of the disclosed Ti-based alloy is poor, and its melting point is high. On the other hand, EP2530176 provides a Ti-based alloy for medical implants, which is composed of TiₐZr_{b}Nb_{c}M_{d}Iₑ in both amorphous and quasicrystal phases, where M may be Ni, Co, Fe, or Mn, and I represents unavoidable impurities. However, it is also disadvantageous for its high melting point.

In view of the shortcoming of the foregoing, existing Ti-based alloy materials, it is necessary to develop a Ti-based alloy that has high biocompatibility and high GFA, and is suitable for additive manufacturing as a perfect medical material.

### SUMMARY

One objective of the present invention is to provide a biocompatible Ti-based alloy, which is made of an alloy having a formula of TiₐZr_{w}Ta_{b}SiₓSn_{y}Co_{z}, wherein a is 40-44; b is 1-5; and a sum of w, x, y, and z is 51-59, in which at least one of y and z is not 0.

In one particular embodiment of the present invention, a is 41.5-42.5; and b is 2.5-3.5.

In another particular embodiment of the present invention, w is 22-48; x is 1-15; y is 1-15; and z is 1-23.

In one particular embodiment of the present invention, the Ti-based alloy is selected from the group consisting of Ti₄₂Zr₃₅Ta₃Si₅Co_{12.5}Sn_{2.5}, Ti₄₂Zr₃₅Ta₃Si₅Co₁₀Sn₅, Ti₄₂Zr₃₅Ta₃Si₅Co_{7.5}Sn_{7.5}, Ti₄₂Zr₃₅Ta₃Si₅Co₅Sn₁₀, Ti₄₂Zr₃₅Ta₃Si₅Co_{2.5}Sn_{12.5}, Ti₄₂Zr₃₅Ta₃Si_{6.25}Sn_{2.5}Co_{11.25}, Ti₄₂Zr₃₅Ta₃Si_{6.25}Sn_{1.25}Co_{12.5}, Ti₄₂Zr₃₅Ta₃Si₅Sn_{3.75}Co_{11.25}, Ti₄₂Zr₃₅Ta₃Si₅Sn_{1.25}Co_{13.75}, Ti₄₂Zr₃₅Ta₃Si_{3.75}Sn₅Co_{11.25}, Ti₄₂Zr₃₅Ta₃Si_{3.75}Sn_{3.75}Co_{12.5}, Ti₄₂Zr₃₅Ta₃Si_{3.75}Sn_{2.5}Co_{13.75}, Ti₄₂Zr₃₅Ta₃Si_{2.5}Sn_{6.25}Co_{11.25}, Ti₄₂Zr₃₅Ta₃Si_{2.5}Sn₅Co_{12.5}, Ti₄₂Zr₃₅Ta₃Si_{2.5}Sn_{3.75}Co_{13.75}, Ti₄₂Zr₃₅Ta₃Si_{2.5}Sn_{2.5}Co₁₅, Ti₄₂Zr₃₅Ta₃Si_{1.25}Sn_{6.25}Co_{12.5}, Ti₄₂Zr₃₅Ta₃Si_{1.25}Sn₅Co_{13.75}, Ti₄₂Zr₃₅Ta₃Si_{1.25}Sn_{3.75}Co₁₅, Ti₄₂Zr₃₅Ta₃Si₀Sn_{3.75}Co_{16.25}, and Ti₄₂Zr₃₅Ta₃Si_{2.5}Sn_{1.25}Co_{16.25}.

In one particular embodiment of the present invention, the Ti-based alloy is an amorphous alloy.

In one particular embodiment of the present invention, the Ti-based alloy has a melting point below 1000° C. and optionally above 800° C.

In one particular embodiment of the present invention, the Ti-based alloy is suitable for additive manufacturing.

In one particular embodiment of the present invention, the Ti-based alloy is in a form of glass ultrafine powders formed by atomization using argon.

In one particular embodiment of the present invention, at least half of the glass ultrafine powders of the Ti-based alloy have a particle size below 53 μm.

In one particular embodiment of the present invention, the glass ultrafine powder of the Ti-based alloy has a form factor of 0.85-1.

### BRIEF DESCRIPTION OF THE DRAWINGS

The sole FIGURE shows the particle-size distribution of the powders of the TiSnCoTi-based alloy system suitable for additive manufacturing.

7

### DETAILED DESCRIPTION OF THE PREFERRED EMBODIMENT

The invention as well as a preferred mode of use, further objectives and advantages thereof will be best understood by reference to the following detailed description of illustrative embodiments when read in conjunction with the accompanying drawings.

Unless stated otherwise in the specification, throughout the specification of the present invention and the appended claims, all the technical and scientific terms referred have the definitions as those known to people of ordinary skill in the art. When used related to any element or feature, the terms “a”, “an”, “the” or the like shall refer to more than one that element or feature, unless stated otherwise in the specification. In the present specification, where any of the terms of“or”, “and”, and “as well as” is used, it actually means “and/or”, unless stated otherwise in the specification. In addition, the terms “comprising” and “including” are both in the nature of open ended transition and represents no exclusiveness. The foregoing definitions are only for illustrative purposes and shall form no limitation to the subject matter of the present invention. Unless stated otherwise in the specification, materials used in the present invention are all commercial available.

For testing properties of different Ti-based alloys having different compositions, alloys of different TiₐZr_{w}Ta_{b}SiₓSn_{y}Co_{z} compositions are taken as subjects, where 40≤a≤44, 1≤b≤5, and the sum of w, x, y, and z is 55, in which at least one of y and z is not 0. Preferably, a is 42, and b is 3. Therein, the factors a, b, w, x, y, and z each represent an atomic percentage (at %) of a particular metal in each unit of the alloy. The foregoing alloys are repeatedly melted into alloy ingots in an electric arc furnace under protection of argon gas, and then the alloy ingots are input into a ribbon maker to be made into long metallic glass ribbons having a thickness of 25-50 μm using a melt spinning process.

By using x-rays and a transmission electron microscope (TEM), it is verified that the made ribbons have their microstructure as amorphous alloys. Afterward, a scanning electron microscope (SEM)/energy dispersive x-ray spectroscopy (EDS) and an electron probe x-ray microanalyzer (EPMA) are used to identify whether there is any differences between the designed composition and the actual composition after smelting for each of the alloys. As it is certained that there is no difference, the ribbons are analyzed using differential scanning calorimetry (DSC) and high-temperature DSC to identify its glass transition temperature (T_{g}) (calculated using the absolute temperature), crystallization temperature (Tₓ), melting temperature (Tₘ), and liquid phase temperature (Tₗ). Then the relevant parameters are applied to indexes for glass forming ability, and the glass forming ability of each alloy compositions is calculated. The aforementioned indexes include:

T_{rg}=T_{g}/Tₗ;

ΔTₓ=Tₓ−T_{g};

γ=Tₓ/(T_{g}+Tₗ); and

γₘ=(2Tₓ−T_{g})/Tₗ.

### COMPARATIVE EXAMPLE

As seen in the references, the existing biomedical implants made of porous, amorphous alloys are all constant in terms of porosity, which is not the same as the structure of human bones. Instead, a bionic implant has a supportive outer layer with relatively compact texture, and an inner layer having progressive arrangement of porosity to allow human texture and body fluid to flow therethrough. Such a complicated geometry can never be made by traditional processing method without using additive manufacturing. The present invention thus aims at providing a powder material that is suitable for being atomized and sprayed as required by additive manufacturing, and that, after subjected to laser sintering, has its microstructure of a metallic glass state.

The Ti₄₂ZrTa₃Si alloy system currently used in the art contains a certain proportion of Si. However, Si has the smallest atomic size in the alloy, and a high Si content leads to high packing density. On the contrary, reducing the proportion of Si is effective in decreasing the alloy's liquid viscosity.

The properties of the Ti₄₂ZrTa₃Si alloy system are shown in Table 1.

TABLE 1

| | Tₘ | Tₗ | ΔTₘ | T_{g} | Tₓ | ΔTₓ | T_{rg} | γₘ | γ |
|---|---|---|---|---|---|---|---|---|---|
| Ti₄₂Zr₄₀Ta₃Si₁₅ | 1620 | 1751 | 131 | 799 | 879 | 80 | 0.456 | 0.548 | 0.345 |
| Ti₄₃Zr₄₁Ta₃Si_{12.5} | 1623 | 1743 | 120 | 766 | 893 | 127 | 0.439 | 0.585 | 0.356 |

The Ti₄₂ZrTa₃Si alloy system has disadvantages related to high viscosity and poor glass forming ability, among others. In order to provide powders suitable for the spraying process in additive manufacturing, the alloy is preferred to have high glass forming ability and low viscosity. However, as reflected in the comparative example shown in Table 1, the content of Si must be 12.5% or more. Thus, the addition of other elements is required for the desired properties.

### Embodiment 1

An TiZrTaSi alloy is used as the substrate with Sn and Co added therein, and is tested for its properties. The properties of the alloy of the present embodiment as tested are shown in Tables 2-4.

TABLE 2
Alloy of TiSn System

| | Tₘ | Tₗ | ΔTₘ | T_{g} | Tₓ | ΔTₓ | T_{rg} | γₘ | γ |
|---|---|---|---|---|---|---|---|---|---|
| Ti₄₂Zr₄₂Ta₃Si₅Sn₈ | 1638 | 1732 | 94 | 815 | 923 | 108 | 0.471 | 0.595 | 0.362 |
| Ti₄₂Zr₄₂Ta₃Si_{7.5}Sn_{5.5} | 1616 | 1709 | 93 | 763 | 900 | 137 | 0.446 | 0.607 | 0.364 |
| Ti₄₂Zr₄₂Ta₃Si₁₀Sn₃ | 1617 | 1703 | 86 | 751 | 900 | 149 | 0.441 | 0.616 | 0.367 |
| Ti₄₂Zr₄₀Ta₃Si_{7.5}Sn_{7.5} | 1618 | 1738 | 120 | 776 | 904 | 128 | 0.446 | 0.594 | 0.360 |
| Ti₄₂Zr₄₀Ta₃Si₁₀Sn₅ | 1611 | 1728 | 117 | 773 | 910 | 137 | 0.447 | 0.606 | 0.364 |
| Ti₄₂Zr₄₀Ta₃Si_{12.5}Sn_{2.5} | 1610 | 1719 | 109 | 799 | 925 | 126 | 0.465 | 0.611 | 0.367 |
| Ti₄₂Zr_{37.5}Ta₃Si_{7.5}Sn₁₀ | 1625 | 1727 | 102 | 852 | 923 | 71 | 0.493 | 0.576 | 0.358 |
| Ti₄₂Zr_{37.5}Ta₃Si₁₀Sn_{7.5} | 1622 | 1733 | 111 | 875 | 928 | 53 | 0.505 | 0.566 | 0.356 |
| Ti₄₂Zr₃₅Ta₃Si₁₅Sn₅ | 1625 | 1730 | 105 | 896 | 926 | 30 | 0.518 | 0.553 | 0.353 |
| Ti₄₀Zr₄₂Ta₃Si_{7.5}Sn_{7.5} | 1613 | 1715 | 102 | 851 | 938 | 87 | 0.496 | 0.598 | 0.366 |

TABLE 3
Alloy of TiCo System

| | Tₘ | Tₗ | ΔTₘ | T_{g} | Tₓ | ΔTₓ | T_{rg} | γₘ | γ |
|---|---|---|---|---|---|---|---|---|---|
| Ti₄₂Zr₃₀Ta₃Si₁₅Co₁₀ | 1132 | 1226 | 94 | 794 | 818 | 24 | 0.648 | 0.687 | 0.405 |
| Ti₄₂Zr_{32.5}Ta₃Si_{12.5}Co₁₀ | 1134 | 1189 | 55 | 796 | 833 | 37 | 0.669 | 0.732 | 0.420 |
| Ti₄₂Zr₃₅Ta₃Si₁₀Co₁₀ | 1130 | 1191 | 61 | 798 | 844 | 46 | 0.670 | 0.747 | 0.424 |
| Ti₄₂Zr_{27.5}Ta₃Si₁₅Co_{12.5} | 1139 | 1240 | 101 | 776 | 808 | 32 | 0.626 | 0.677 | 0.401 |
| Ti₄₂Zr₃₀Ta₃Si_{12.5}Co_{12.5} | 1136 | 1210 | 74 | 778 | 813 | 35 | 0.643 | 0.701 | 0.409 |
| Ti₄₂Zr_{32.5}Ta₃Si₁₀Co_{12.5} | 1137 | 1212 | 75 | 771 | 822 | 51 | 0.636 | 0.720 | 0.415 |
| Ti₄₂Zr₃₅Ta₃Si_{7.5}Co_{12.5} | 1134 | 1199 | 65 | 758 | 826 | 68 | 0.632 | 0.746 | 0.422 |
| Ti₄₂Zr_{37.5}Ta₃Si₅Co_{12.5} | 1131 | 1201 | 70 | 781 | 850 | 69 | 0.650 | 0.765 | 0.429 |
| Ti₄₂Zr₂₅Ta₃Si₁₅Co₁₅ | 1143 | 1303 | — | 799 | 824 | 25 | 0.613 | 0.652 | 0.392 |
| Ti₄₂Zr_{27.5}Ta₃Si_{12.5}Co₁₅ | 1143 | 1201 | 58 | 779 | 817 | 38 | 0.649 | 0.712 | 0.413 |
| Ti₄₂Zr₃₀Ta₃Si₁₀Co₁₅ | 1139 | 1216 | 67 | 772 | 818 | 47 | 0.635 | 0.711 | 0.411 |
| Ti₄₂Zr_{32.5}Ta₃Si_{7.5}Co₁₅ | 1139 | 1220 | 81 | 777 | 834 | 57 | 0.637 | 0.730 | 0.418 |
| Ti₄₂Zr₃₅Ta₃Si₅Co₁₅ | 1131 | 1201 | 70 | 745 | 817 | 72 | 0.620 | 0.740 | 0.420 |
| Ti₄₂Zr_{22.5}Ta₃Si₁₅Co_{17.5} | 1143 | 1386 | 243 | — | 814 | — | — | — | — |
| Ti₄₂Zr₂₅Ta₃Si_{12.5}Co_{17.5} | 1143 | 1234 | 91 | 808 | 830 | 22 | 0.655 | 0.690 | 0.406 |
| Ti₄₂Zr_{27.5}Ta₃Si₁₀Co_{17.5} | 1133 | 1224 | 91 | 799 | 832 | 33 | 0.653 | 0.707 | 0.411 |
| Ti₄₂Zr₃₀Ta₃Si_{7.5}Co_{17.5} | 1138 | 1228 | 90 | 783 | 833 | 50 | 0.638 | 0.719 | 0.414 |
| Ti₄₂Zr_{32.5}Ta₃Si₅Co_{17.52C} | 1136 | 1223 | 87 | 760 | 831 | 71 | 0.621 | 0.738 | 0.419 |
| Ti₄₂Zr₂₅Ta₃Si₁₀Co₂₀ | 1140 | 1291 | 151 | 805 | 841 | 36 | 0.624 | 0.679 | 0.401 |
| Ti₄₂Zr₃₀Ta₃Si₅Co₂₀ | 1132 | 1292 | 160 | 794 | 852 | 58 | 0.615 | 0.704 | 0.408 |
| Ti₄₂Zr₁₅Ta₃Si₁₅Co₂₅ | — | 1558 | — | — | 857 | — | — | — | — |
| Ti₄₂Zr₂₀Ta₃Si₁₀Co₂₅ | — | 1265 | — | 822 | 855 | 33 | 0.650 | 0.702 | 0.410 |

TABLE 4
Alloy of TiSnCo System

| | Tₘ | Tₗ | ΔTₘ | T_{g} | Tₓ | ΔTₓ | T_{rg} | γₘ | γ |
|---|---|---|---|---|---|---|---|---|---|
| Ti₄₂Zr₃₅Ta₃Si₅Co_{12.5}Sn_{2.5} | 1142 | 1210 | 68 | 761 | 842 | 81 | 0.629 | 0.763 | 0.427 |
| Ti₄₂Zr₃₅Ta₃Si₅Co₁₀Sn₅ | 1144 | 1212 | 68 | 809 | 873 | 64 | 0.667 | 0.773 | 0.432 |
| Ti₄₂Zr₃₅Ta₃Si₅Co_{7.5}Sn_{7.5} | 1144 | 1198 | 54 | 803 | 874 | 71 | 0.670 | 0.789 | 0.437 |
| Ti₄₂Zr₃₅Ta₃Si₅Co₅Sn₁₀ | — | 1202 | — | 812 | 876 | 64 | 0.676 | 0.782 | 0.435 |
| Ti₄₂Zr₃₅Ta₃Si₅Co_{2.5}Sn_{12.5} | 1685 | 1706 | 21 | 848 | 873 | 25 | 0.497 | 0.526 | 0.342 |

TABLE 5
Alloy of TiSnCo System (with little Sn)

| | Tₘ | Tₗ | ΔTₘ | T_{g} | Tₓ | ΔTₓ | T_{rg} | γₘ | γ |
|---|---|---|---|---|---|---|---|---|---|
| Ti₄₂Zr₃₅Ta₃Si_{6.25}Sn_{2.5}Co_{11.25} | 1142 | 1216 | 74 | 795 | 860 | 65 | 0.654 | 0.761 | 0.428 |
| Ti₄₂Zr₃₅Ta₃Si_{6.25}Sn_{1.25}Co_{12.5} | 1138 | 1204 | 66 | 781 | 848 | 67 | 0.649 | 0.760 | 0.427 |
| Ti₄₂Zr₃₅Ta₃Si₅Sn_{3.75}Co_{11.25} | 1141 | 1207 | 66 | 766 | 854 | 88 | 0.635 | 0.780 | 0.433 |
| Ti₄₂Zr₃₅Ta₃Si₅Sn_{1.25}Co_{13.75} | 1141 | 1211 | 70 | 838 | 892 | 54 | 0.692 | 0.781 | 0.435 |
| Ti₄₂Zr₃₅Ta₃Si_{3.75}Sn₅Co_{11.25} | 1139 | 1202 | 63 | 791 | 869 | 78 | 0.658 | 0.788 | 0.436 |
| Ti₄₂Zr₃₅Ta₃Si_{3.75}Sn_{3.75}Co_{12.5} | 1141 | 1204 | 63 | 770 | 860 | 90 | 0.640 | 0.789 | 0.436 |
| Ti₄₂Zr₃₅Ta₃Si_{3.75}Sn_{2.5}Co_{13.75} | 1139 | 1212 | 73 | 764 | 852 | 88 | 0.630 | 0.776 | 0.431 |
| Ti₄₂Zr₃₅Ta₃Si_{2.5}Sn_{6.25}Co_{11.25} | 1144 | 1204 | 60 | 794 | 876 | 82 | 0.659 | 0.796 | 0.438 |
| Ti₄₂Zr₃₅Ta₃Si_{2.5}Sn₅Co_{12.5} | 1145 | 1204 | 59 | 792 | 876 | 84 | 0.658 | 0.797 | 0.439 |
| Ti₄₂Zr₃₅Ta₃Si_{2.5}Sn_{3.75}Co_{13.75} | 1146 | 1214 | 68 | 776 | 866 | 90 | 0.639 | 0.787 | 0.435 |
| Ti₄₂Zr₃₅Ta₃Si_{2.5}Sn_{2.5}Co₁₅ | 1146 | 1211 | 65 | 754 | 858 | 104 | 0.623 | 0.794 | 0.437 |
| Ti₄₂Zr₃₅Ta₃Si_{1.25}Sn_{6.25}Co_{12.5} | 1139 | 1203 | 64 | 802 | 892 | 90 | 0.667 | 0.816 | 0.445 |
| Ti₄₂Zr₃₅Ta₃Si_{1.25}Sn₅Co_{13.75} | 1147 | 1209 | 62 | 777 | 888 | 111 | 0.643 | 0.826 | 0.447 |
| Ti₄₂Zr₃₅Ta₃Si_{1.25}Sn_{3.75}Co₁₅ | 1141 | 1207 | 66 | 780 | 884 | 104 | 0.646 | 0.819 | 0.445 |
| Ti₄₂Zr₃₅Ta₃Si₀Sn_{3.75}Co_{16.25} | 1145 | 1205 | 60 | 766 | 876 | 110 | 0.636 | 0.818 | 0.444 |
| Ti₄₂Zr₃₅Ta₃Si_{2.5}Sn_{1.25}Co_{16.25} | 1133 | 1202 | 69 | 735 | 848 | 113 | 0.611 | 0.800 | 0.438 |

As shown in Table 2, where the TiZrTaSi alloy is used as the substrate, with 2.5-10 atomic percent of Sn added therein, its ΔTₓ is of 30-149, and its γₘ is roughly of 0.5-0.61. As compared to the addition of 10% of Sn, the addition of 5% of Sn is more helpful to decrease the value of ΔTₓ.

In addition, as shown in Table 3, where the TiZrTaSi alloy is used as the substrate, with 7-17.5 atomic percent of Co added therein, its ΔTₓ is of 22-72, and its γₘ is roughly of 0.65-0.76. By comparing Sn and Co in terms of glass forming ability, it is learned that the addition of Co does improve the alloy's glass forming ability. Thus, it is envisaged that an alloy with preferred glass forming ability can be made by using the TiZrTaSi alloy as the substrate, and adding Sn or Co at a certain mole ratio.

Additionally, as shown in Table 4, where the TiZrTaSi alloy is used as the substrate, with 2.5-12.5 atomic percent of Co and 2.5-12.5 atomic percent of Sn added therein, its γₘ is as high as more than 0.76. Thus, a Ti-based alloy may be improved in terms of glass forming ability by mixing Co and Sn in a specific proportion therein.

Besides, as shown in Table 5, where the TiZrTaSi-based alloy is used as the substrate, with Sn or Co added therein following a specific proportion, and is further tested for the positive impact of the addition of Sn in a mole ratio below 6.25 on its glass forming ability, the value of γₘ is at least 0.78. In another preferred embodiment, the value of γₘ is as high as 0.8-0.82.

The biocompatible Ti-based alloy suitable for additive manufacturing preferably has low viscosity, low melting point, and good glass forming ability (GFA). An alloy having low melting point usually has good glass forming ability, and the low melting point means that low power laser is sufficient for working with it. In the embodiments of the present invention, while the addition of Sn effectively decreases the alloy's viscosity and enhances the alloy's glass forming ability, it has no effect on the alloy's melting point, yet increases the value of ΔTₓ. On the other hand, the addition of Co effectively reduces the alloy's viscosity, melting point, and ΔTₓ, and is favorable to the alloy's glass forming ability.

### Embodiment 2

Since the Ti-based alloy has high metallic glass viscosity that is unfavorable to powder spraying, the present invention provides another method for making powders of the Ti-based alloy of Embodiment 1 for spraying. The resulting powders are suitable for additive manufacturing and feature for low surface roughness and high circularity.

Referring to the alloy as described herein related to Embodiment 1, Ti₄₂Zr₄₀Ta₃Si_{7.5}Sn_{7.5} is used to make powders for spraying. The method comprises: placing alloy ingots in a crucible, and heating the alloy ingots into liquid phase using radio frequency; transferring the liquid-phase alloy into a heat-insulating crucible, and pressurizing the heat-insulating crucible so that the liquid phase alloy in the heat-insulating crucible flows into a zone of atomizing spray nozzles in the heat-insulating crucible; and performing atomization using argon (Ar) on the liquid phase alloy coming out of the zone of the atomizing spray nozzles, so as to obtain the powders of the alloy.

The foregoing alloy powders are fine in terms of particle size, and have low surface roughness, thereby presenting desired flowability for powder-spreading and powder bed density, which are suitable for additive manufacturing. The alloy powders made using the foregoing method have their particle-size distribution shown in the sole FIGURE. For the TiSnCo alloy system, the proportion of powders having a particle diameter below 37 μm is 26%, the proportion of powders having a particle diameter of 37-53 μm is 25.7%, and the proportion of powders having a particle diameter below 53 μm is 51.7%.

What is claimed is:

1. A biocompatible Ti-based alloy, which is formed of an alloy having a formula of TiₐZr_{w}Ta_{b}SiₓSn_{y}Co_{z}, wherein a is 40-44; b is 1-5; a sum of w, x, y and z is 51-59; and at least one of y and z is not 0.

2. The Ti-based alloy of claim 1, wherein a is 41.5-42.5, and b is 2.5-3.5.

3. The Ti-based alloy of claim 2, wherein w is 22-48; x is 1-15; y is 1-15; and z is 1-23.

4. The Ti-based alloy of claim 1, wherein the Ti-based alloy is selected from the group consisting of Ti₄₂Zr₃₅Ta₃Si₅Co_{12.5}Sn_{2.5}, Ti₄₂Zr₃₅Ta₃Si₅Co₁₀Sn₅, Ti₄₂Zr₃₅Ta₃Si₅Co_{7.5}Sn_{7.5}, Ti₄₂Zr₃₅Ta₃Si₅Co₅Sn₁₀, Ti₄₂Zr₃₅Ta₃Si₅Co_{2.5}Sn_{12.5}, Ti₄₂Zr₃₅Ta₃Si_{6.25}Sn_{2.5}Co_{11.25}, Ti₄₂Zr₃₅Ta₃Si_{6.25}Sn_{1.25}Co_{12.5}, Ti₄₂Zr₃₅Ta₃Si₅Sn_{3.75}Co_{11.25}, Ti₄₂Zr₃₅Ta₃Si₅Sn_{1.25}Co_{13.75}, Ti₄₂Zr₃₅Ta₃Si_{3.75}Sn₅Co_{11.25}, Ti₄₂Zr₃₅Ta₃Si_{3.75}Sn_{3.75}Co_{12.5}, Ti₄₂Zr₃₅Ta₃Si_{3.75}Sn_{2.5}Co_{13.75}, Ti₄₂Zr₃₅Ta₃Si_{2.5}Sn_{6.25}Co_{11.25}, Ti₄₂Zr₃₅Ta₃Si_{2.5}Sn₅Co_{12.5}, Ti₄₂Zr₃₅Ta₃Si_{2.5}Sn_{3.75}Co_{13.75}, Ti₄₂Zr₃₅Ta₃Si_{2.5}Sn_{2.5}Co₁₅, Ti₄₂Zr₃₅Ta₃Si_{1.25}Sn_{6.25}Co_{12.5}, Ti₄₂Zr₃₅Ta₃Si_{1.25}Sn₅Co_{13.75}, Ti₄₂Zr₃₅Ta₃Si_{1.25}Sn_{3.75}Co₁₅, Ti₄₂Zr₃₅Ta₃Si₀Sn_{3.75}Co_{16.25}, and Ti₄₂Zr₃₅Ta₃Si_{2.5}Sn_{1.25}Co_{16.25}.

5. The Ti-based alloy of claim 1, wherein the Ti-based alloy is an amorphous alloy.

6. The Ti-based alloy of claim 1, wherein the Ti-based alloy has a melting point below 1000° C.

7. The Ti-based alloy of claim 1, wherein the Ti-based alloy is suitable for additive manufacturing.

8. The Ti-based alloy of claim 7, wherein the Ti-based alloy is in a form of glass ultrafine powders formed by atomization using argon.

9. The Ti-based alloy of claim 8, wherein at least half of the glass ultrafine powders have a particle size below 53 μm.

10. The Ti-based alloy of claim 8, wherein the glass ultrafine powder has a form factor of 0.85-1.
